(19) United States
(12) Patent Application Publication
(10) Pub. No.: US 2002/0125411 A1
(43) Pub. Date: Sep. 12, 2002

(54) Method and apparatus for reducing specular reflection from a scannable surface

(76) Inventor: Orrin D. Christy, North Tonawanda, NY (US)

Correspondence Address: NIXON & VANDERHYE P.C., 8th Floor, 1100 North Glebe Road, Arlington, VA, 22201, US

(21) Appl. No.: 10/091,597

(22) Filed: Mar. 7, 2002

Related U.S. Application Data
(60) Provisional application No. 60/273,970, filed on Mar. 8, 2001.

(51) Int. Cl. G02F 1/01

(52) U.S. Cl. 250/225

(57) ABSTRACT

We have discovered that it is possible to create a beam of light that is polarized in a linear fashion from the illuminator. This beam is directed to the bar coded labels (should not be limited to these only) at a relatively low angle of incidence. The beam is reflected toward the sensor (camera) optics. Before reaching the sensor, it passes through a second polarizing filter which blocks the transmission of the direct specular reflection from the label. The sensor only receives the information from the substrate by the diffuse reflection. The concept was developed specifically with the linerless label stock in mind. However, the present invention can be applied to linerless label sales to UPS and possibly other freight carriers, and/or to other types of labels and surfaces for optical scanning.

### FIELD OF THE INVENTION

This invention relates to optical scanning, and more particularly to techniques for achieving higher reliability of automatic optical scanning. Still more particularly, the invention relates to method and apparatus for using polarized light to increase the reliability of optically scanning linerless label stock.

### SUMMARY AND BACKGROUND OF THE INVENTION

Parcel companies such as the United Parcel Service (UPS) often use automatic scanner/readers in their freight hub locations for faster and more automated routing of the parcels to their destination delivery points. Two such examples of such automatic scanner/reader devices are the AccuSort AccuVision decoder and the CPSI Vision Systems Lightning 500E reader.

The advantage of such automatic scanner/reader units is the high-speed automated package identification and routing, such systems are at the mercy of the orientation of the bar coded symbol with respect to the package it is mounted on. In certain instances, packages may be oriented so as to create a direct reflection path between the illuminator of the reader and its imaging camera system. This is not a problem for the sensor if the reflection is diffuse as would be the case with a dull or matte finish. If the surface happens to be coated with a glossy material (e.g., silicone, cellophane tape, oil such as skin oil, glossy varnish, etc.), direct reflection of the light from the illuminator can “blind” the scanner. This blinding would then result in a misread or no-read condition from the decoder.

One such injurious glossy coating is found on the silicone overcoat of Linerless Labels manufactured by Moore Business Forms. Initial tests of the Moore Linerless Labels proved to have an unacceptable high rate of misreads using automated bar code scanning equipment at the United Parcel Service (UPS) verification center. In verification trials at the UPS facility, scanning misread rates were on the order of 2%. The UPS specification on misread rates is 0.02%. The poor read rates are a result of the glint or specular reflections encountered from the UPS bar code interpreting equipment. Immediately apparent with the glossy and matte finishes of the silicone layer coating was the glint or direct reflection from the illuminator back into the camera optics. Such a reflection is called specular reflection. This specular reflection can highly overpower the printed characters on the substrate. Since the automated scanners have no control over the specific angle of the bar code label, chances are that many of the labels will suffer from this specular reflection problem which would cause a misread condition. This is not only a problem with the silicone over coating on the linerless product. It can also show up on standard labels that may have a smudge of grease, oil, or even skin oil over the scannable substrate (demonstrated).

Orientation of the label within the scanning system is important to prevent the direct reflection (specular reflection) of the illuminator into the camera. Based on the scanning trials performed, we can say that a good number of bar coded labels (98%) will not line up in such an orientation and will read successfully. Presently the misread fraction, 2 in 100, does not satisfy the ultimate goal of 2 in 10,000.

The glossiness of the silicone overcoat can be reduced with the addition of materials that create a more matte-like surface. However, on a microscopic level, much of the surface would still cause the specular reflection of the illuminator light straight into the camera, thereby causing it to be blinded with the resulting misread of the label.

The present invention overcomes this problem of the specular reflection that is evident when the linerless label material is used.

If a beam of natural light (non-polarized) is incident upon a surface of a transparent substance at an angle equal to the polarization angle (Brewster Angle), the component vibrating in the plane of incidence is totally refracted. The reflected component is linearly polarized with the optical vector parallel to the reflector's surface. If the beam of light is incident at an angle different to the polarization angle, the degree of polarization diminishes. Transparent materials generally have an index of refraction near 1.3 to 1.6 that yields a polarization angle of near 50 degrees. The angle of incidence is less than 15 degrees, more nearly 7 degrees, in commercial scanning equipment, so very little polarization is present. A polarizing filter in the optical path of the camera is of little use.

We have discovered that it is possible to create a beam of light that is polarized in a linear fashion from the illuminator. This beam is directed to the bar coded labels (should not be limited to these only) at a relatively low angle of incidence. The beam is reflected toward the sensor (camera) optics. Before reaching the sensor, it passes through a second polarizing filter which blocks the transmission of the direct specular reflection from the label. The sensor only receives the information from the substrate by the diffuse reflection.

The concept was developed specifically with the linerless label stock in mind. However, the present invention can be applied to linerless label sales to UPS and possibly other freight carriers, and/or to other types of labels and surfaces for optical scanning.

### BRIEF DESCRIPTION OF THE DRAWINGS

These and other features and advantages provided by the invention will be better and more completely understood by referring to the following detailed description of presently preferred embodiments in conjunction with the drawings, of which:

FIG. 1 is a schematic illustration of a preferred embodiment of the present invention.

### DETAILED DESCRIPTION OF THE DRAWINGS

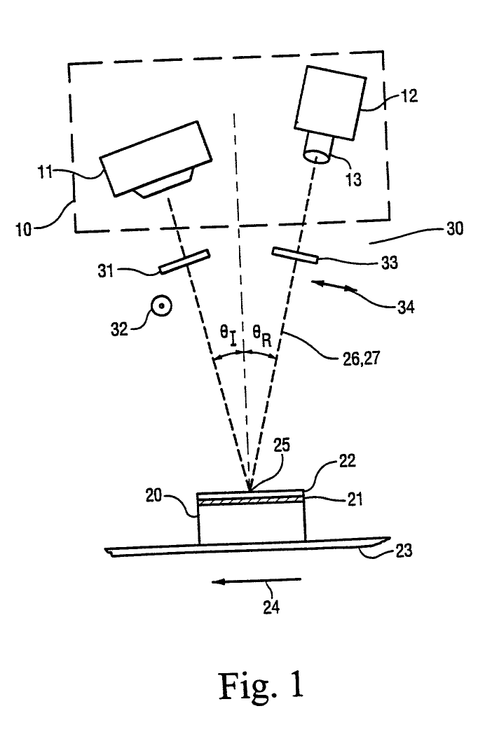

Referring to FIG. 1, a vision system 10 consists of illumination source 11 and inspection camera 12. Illumination source 11 is normally a high intensity, metallic vapor light (sodium vapor) but is not limited necessarily to that type of light source. Regardless, the illumination source is a non-polarized light source.

Illuminating source 11 directs the incident beam of light toward the label 25 on a package 20 that is being transported on a moving conveyor device 23 moving in a direction 24. The incident ray of light strikes the label at an angle of incidence 26 that is shown as θ₁. The reflected ray exits the label 25 at an angle 27 shown as θ_{R}, which is equal to the angle of incidence. The label is shown to have two components in this illustration. The substrate 21 carries the coded information that is to be interpreted by the scanner. On top of the substrate is a glossy or semi glossy (matte) overcoating 22 which can cause a specular reflection from the surface straight into the sensor which would obscure any information which could be observed on the substrate layer 21. This situation is similar to becoming “snow blind” when the direct reflection of the sun from a fresh coat of snow creates a blinding glare obscuring a view of any detail that might be seen.

The addition of 2 polarizing filters 31 and 33 reduces the problems with the specular reflection. On the illuminator side, polarizing filter 31 selectively removes the component of non-polarized light in one plane and only allows passage of linearly polarized light in the direction of the vector 32, which is oriented so the polarization component would be vibrating perpendicular to the page. Now the linearly polarized light follows the same path to the label reflecting off at the same angle back toward the sensor (camera). On the path to the camera 12, before reaching focusing optics 13, the reflected beam encounters a second polarizing element 33. This element is oriented such that the optical vector 34 allows the linearly polarized light in the plane of the paper to pass through the filter, on to the camera.

The polarization filters used in this application were made of a dichroic material (Edmund Scientific Company Linear Polarizing Laminated Film). Other means for polarizing the light could also include the application of the reflected polarization angle, birefringent materials, and a number of other alternatives.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the scope of the appended claims.

We claim:

1. A scanning apparatus characterized by a source of non-polarized illuminating radiation that directs radiation toward a substrate surface in order to scan said substrate surface, and a sensing arrangement coupled to receive radiation reflected from the substrate surface, said scanning apparatus further characterized by:
a first polarizing element disposed to receive said non-polarized radiation from said source, said first polarizing filter selectively removing, from the radiation directed toward the substrate surface, a component of non-polarized radiation in a first plane and allowing passage of radiation that is linearly polarized in an orientation vibrating in a direction perpendicular to the substrate surface, and;
a second polarizing element disposed to receive radiation reflected by said substrate surface, said second polarizing element allowing the linearly polarized radiation that is reflected from the substrate surface in the plane of said substrate surface to pass therethrough.

2. The apparatus of claim 1 further characterized in that said first polarizing element comprises a dichroic material.

3. The apparatus of claim 1 further characterized in that said second polarizing element comprises a dichroic material.

4. The apparatus of claim 1 further characterized in that at least one of said first and second polarizing elements comprises a linearly polarizing laminated film.

5. The apparatus of claim 1 further characterized in that at least one of said first and second polarizing elements applies a reflected polarization angle.

6. The apparatus of claim 1 further characterized in that said at least one of said polarizing elements comprises a birefringent material.

7. The apparatus of claim 1 further characterized in that said sensing arrangement comprises a camera.

8. The apparatus of claim 1 further characterized in that said sensing arrangement comprises a two-dimensional sensor.

9. The apparatus of claim 1 further characterized in that said substrate surface has a glossy or semi-glossy overcoating which can cause a specular reflection from the surface straight into a sensor that would obscure information which could otherwise be observed from the substrate surface.

10. The apparatus of claim 1 further characterized in that said illuminating source and first polarizing element directs said illuminating radiation towards said substrate surface at an angle.

11. The apparatus as in claim 10 further characterized in that said angle is greater than 0° but less than 45°.

12. A method of using non-polarized illuminating radiation directed toward a substrate surface to scan said substrate surface, said method further characterized by:
selectively removing, from the radiation directed toward the substrate surface, a component of non-polarized radiation in a first plane and allowing passage of radiation that is linearly polarized in an orientation vibrating in a direction perpendicular to the substrate surface, and;
allowing only linearly polarized radiation that is reflected from the substrate surface in the plane of said substrate surface to pass to a sensing element.

13. The method of claim 12 further characterized by filtering said radiation with a dichroic material.

14. The method of claim 12 further characterized by filtering said radiation with a linearly polarizing laminated film.

15. The method of claim 12 further characterized by applying a reflected polarization angle to said radiation.

16. The method of claim 12 further characterized by filtering said radiation with a birefringent material.

17. The method of claim 12 further characterized by sensing said radiation with a camera.

18. The method of claim 12 further characterized by sensing said reflected radiation with a two-dimensional sensor.

19. The method of claim 12 further characterized in that said substrate surface has a glossy or semi-glossy overcoating which can cause a specular reflection from the surface straight into a sensor that would obscure information which could otherwise be observed from the substrate surface.

20. The method of claim 12 further characterized by directing said illuminating radiation towards said substrate surface at an angle.

21. The method as in claim 20 further characterized in that said angle is greater than 0° but less than 45°.
